(19) United States
(12) Patent Application Publication
(10) Pub. No.: US 2014/0201060 A1
(43) Pub. Date: Jul. 17, 2014

(54) COMPUTER PROGRAM, SYSTEM, AND METHOD FOR PROVIDING A CONSUMER WITH IMMEDIATE ACCESS TO FUNDS VIA A HYBRIDIZED SECURED LINE OF CREDIT

(71) Applicant: HRB TAX GROUP, INC., Kansas City, MO (US)

(72) Inventors: Todd C. Rice, Prairie Village, KS (US); Brandon Lorey, Olathe, KS (US)

(73) Assignee: HRB Tax Group, Inc., Kansas City, MO (US)

(21) Appl. No.: 13/840,193

(22) Filed: Mar. 15, 2013

Related U.S. Application Data
(60) Provisional application No. 61/752,284, filed on Jan. 14, 2013.

(51) Int. Cl. G06Q 40/02

(52) U.S. Cl. CPC G06Q 40/025
USPC 705/38

(57) ABSTRACT

A hybridized secured credit financial product provides a consumer immediate access to funds corresponding to at least a portion of a line of credit before collateral securing the line of credit is realized. The consumer applies for a secured lined of credit. If approved, the consumer opens a first financial account that is a secured credit account. Collateral to secure the secured credit account is provided via a source of collateral funds, such as a onetime or periodic impending payment, associated with the consumer and deposited into a second financial account associated with the consumer. The consumer is allowed access to at least a portion of the line of credit before the collateral is actually deposited into the second financial account.

### RELATED APPLICATION

This non-provisional patent application claims priority benefit, with regard to all common subject matter, of earlier-filed U.S. Provisional Patent Application No. 61/752,284, filed Jan. 14, 2013, and entitled “COMPUTER PROGRAM, SYSTEM, AND METHOD FOR PROVIDING A CONSUMER WITH IMMEDIATE ACCESS TO FUNDS VIA A HYBRIDIZED SECURED LINE OF CREDIT.” The identified earlier-filed provisional patent application is hereby incorporated by reference in its entirety into the present application.

### FIELD

Embodiments of the present invention are broadly directed to a computer program, system, and method for providing hybridized secured lines of credit to consumers. More particularly, embodiments of the present invention are directed to providing a consumer with access to at least a portion of funds associated with a hybridized secured line of credit before collateral that secures the line of credit is realized and/or the collateralizing funds have cleared.

### BACKGROUND

Consumers who are entitled to onetime or periodic payments, such as onetime tax refunds or regular payments from a retirement annuity or government social security distribution, may require access to the monetary funds corresponding to such impending payments before the payments are actually received. For example, a consumer who files her taxes and receives an indication that she is entitled to a tax refund must often wait four to six weeks before she receives the tax refund in the form of a physical check or direct deposit. However, such a consumer may have an immediate need to access the monetary funds associated with the tax refund and is, therefore, unable to wait the four to six weeks to receive the payment. Similarly, a consumer who participates in a retirement annuity program may be entitled to receive a monthly or yearly distribution of funds associated with the annuity. However, such a consumer may have an immediate need to access the monetary funds associated with the distribution and is unable to wait for the distribution to actually be disbursed.

### SUMMARY

Embodiments of the present invention provide for a computer program, a method, and a system directed to a hybridized secured credit financial product that provides a consumer immediate access to funds corresponding to at least a portion of a line of credit before collateral securing the line of credit is realized. Broadly, the consumer applies for a secured lined of credit. If approved, the consumer opens a first financial account that is a secured credit account. Collateral to secure the secured credit account is provided via a source of collateral funds, such as a onetime or periodic impending payment, associated with the consumer and deposited into a second financial account associated with the consumer. In embodiments of the present invention, the consumer is allowed access to at least a portion of the line of credit for the secured credit account before the collateral is actually deposited into the second financial account.

Embodiments of the present invention thus perform the following steps: receive a request, from a consumer, to open a first financial account that is a secured credit account; determine a collateral funding amount available from a source of collateral funds associated with the consumer, wherein the collateral funding amount is used as collateral for the secured credit account; establish a second financial account for depositing of the collateral funding amount in said second financial account; determine an initial credit limit for the secured credit account, wherein the initial credit limit represents an initial monetary amount available to the consumer for a period of time prior to all of the collateral funding amount being deposited in said second financial account; determine a regular credit limit for the secured credit account, wherein the regular credit limit represents a regular monetary amount available to the consumer after all of the collateral funding amount has been deposited in said second financial account; provide access to the consumer, via the secured credit account and prior to all of the collateral funding amount being deposited in said second financial account, of the initial monetary amount, such that the consumer may access the initial monetary amount using the consumer's secured credit account and prior to the second financial account being fully funded with the collateral amount; receive notice that all of the collateral funding amount is deposited into the second financial account; and provide access to the consumer, via the secured credit account and only after all of the collateral funding amount is deposited in said second financial account, of the regular monetary amount, such that the consumer may access the regular monetary amount using the consumer's secured credit account and only after the second financial account is fully funded with the collateral amount.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a flow chart of a method of providing a consumer immediate access to funds corresponding to at least a portion of a line of credit before collateral securing the line of credit is realized; and

FIG. 2 is a schematic depiction of a system that implements the method and computer program having the steps set forth in FIG. 1 and in accordance with other embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Embodiments of the present invention are directed to a computer program, a system, and a method for providing a consumer with a hybridized secured credit financial product that gives the consumer immediate access to monetary funds associated with a secured credit account (i.e., a secured line of credit or secured credit card). Collateral to secure the secured credit account is provided via a source of collateral funds associated with the consumer and deposited into a second financial account associated with the consumer. As used herein, a consumer is an individual and/or entity desiring to obtain a secured line of credit. The secured line of credit can be implemented via the secured credit account, which provides the consumer with immediate access to at least a portion of the secured line of credit. In embodiments of the present invention, the consumer can access the secured credit account funds via a general purpose prepaid card or traditional credit card, as discussed in detail below. As used herein, “immediate access” is defined as at least within twenty-four, twelve, six, or one hour of the consumer establishing, applying for, or being approved for the secured credit account. It is to be appreciated that the immediate access to funds provided by the present invention is within a few hours to a few minutes of the consumer applying for the secured credit account, and as such, the consumer need not wait months, weeks, or even days to access funds associated with an impending payment. It is contemplated that the consumer will be provided immediate access to funds within the same meeting, online session, or other singular event entailing the consumer also applying and being approved for the financial product.

As discussed below, the consumer is provided immediate access to at least a portion of the line of credit prior to the collateral for securing the secured credit account being deposited into the second financial account, is realized, is cleared, is associated with the second financial account, or is otherwise available as collateral (individually or collectively, “collateral is secured”). Only after the collateral is secured is the consumer provided access to the full secured line of credit for the secured credit account. The secured credit account is thus a hybridized secured credit account, in that a first portion of the credit line is immediately available to the consumer, and a second portion of the credit line is available to the consumer only after the collateral is secured. In embodiments of the present invention, the computer program instructs a processor to perform the following steps: receive a request, from a consumer, to open a first financial account that is a secured credit account; determine a collateral funding amount available from a source of collateral funds associated with the consumer, wherein the collateral funding amount is used as collateral for the secured credit account; establish a second financial account for depositing of the collateral funding amount in said second financial account; determine an initial credit limit for the secured credit account, wherein the initial credit limit represents an initial monetary amount available to the consumer for a period of time prior to all of the collateral funding amount being deposited in said second financial account; determine a regular credit limit for the secured credit account, wherein the regular credit limit represents a regular monetary amount available to the consumer after all of the collateral funding amount has been deposited in said second financial account; provide access to the consumer, via the secured credit account and prior to all of the collateral funding amount being deposited in said second financial account, of the initial monetary amount, such that the consumer may access the initial monetary amount using the consumer's secured credit account and prior to the second financial account being fully funded with the collateral amount; receive notice that all of the collateral funding amount is deposited into the second financial account; and provide access to the consumer, via the secured credit account and only after all of the collateral funding amount is deposited in said second financial account, of the regular monetary amount, such that the consumer may access the regular monetary amount using the consumer's secured credit account and only after the second financial account is fully funded with the collateral amount. The computer program of the present invention instructs a processor to perform the method of the present invention, and the system of the present invention comprises a computing device having a memory and a processor for performing the above steps.

### System Description

The system of embodiments of the present invention may comprise computing devices, servers, and communications networks to facilitate the functions and features described herein. The computing devices and servers may comprise any number and combination of processors, controllers, integrated circuits, programmable logic devices, or other data and signal processing devices for carrying out the functions described herein, and may additionally comprise one or more memory storage devices, transmitters, receivers, and/or communication busses for communicating with the various devices of the system. In various embodiments of the invention, the computing devices may comprise a memory element, a communication component, a display, and/or a user interface.

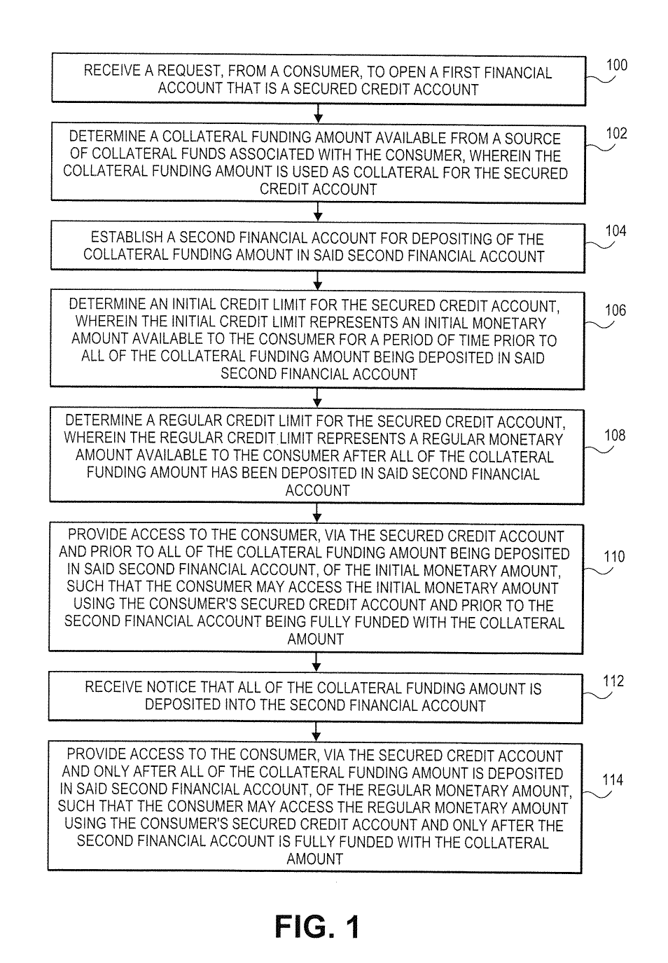

The computer program of embodiments of the present invention comprises a plurality of code segments executable by a computing device for performing the steps of the method of the present invention. The steps of the method may be performed in the order shown in FIG. 1, or they may be performed in a different order, unless otherwise expressly stated. Furthermore, some steps may be performed concurrently as opposed to sequentially. Also, some steps may be optional.

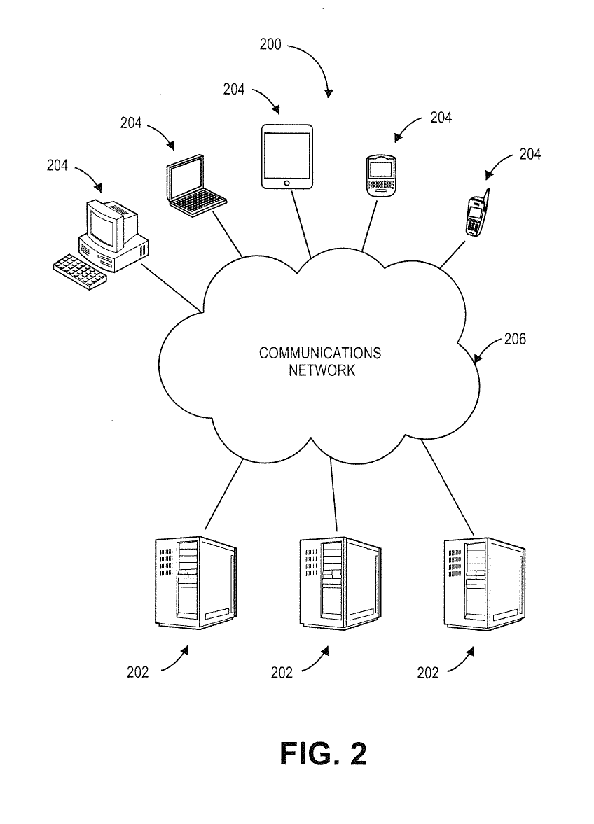

The computer program, system, and method of embodiments of the present invention may be implemented in hardware, software, firmware, or combinations thereof using system 200, shown in FIG. 2, which broadly comprises server devices 202, computing devices 204, and a communications network 206. The server devices 202 may include computing devices that provide access to one or more general computing resources, such as Internet services, electronic mail services, data transfer services, and the like. The server devices 202 may also provide access to one or more databases, including a consumer database that stores information particular to each consumer that obtains the financial product described herein, a financial institution database that includes secured credit account information, rules for underwriting a secured credit account, and other financial institution information relevant to the present invention, and an administrator database that includes financial product offerings, information regarding consumers who have chosen the described financial product, and other information relevant to the present invention. The databases may also store other information and data necessary for the implementation of the computer program, method, and embodiments of the present invention.

The server devices 202 and computing devices 204 may include any device, component, or equipment with a processing element and associated memory elements. The processing element may implement operating systems, and may be capable of executing the computer program, which is also generally known as instructions, commands, software code, executables, applications, apps, and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, the server devices 202 may further include file stores comprising a plurality of hard disk drives, network attached storage, or a separate storage network.

The computing devices 204 may specifically include mobile communication devices (including wireless devices), work stations, desktop computers, laptop computers, palmtop computers, tablet computers, portable digital assistants (PDA), smart phones, scanners, cash registers, cash drawers, printers, and the like, or combinations thereof. Various embodiments of the computing device 204 may also include voice communication devices, such as cell phones or landline phones. In preferred embodiments, the computing device 204 will have an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI enables users (i.e., the consumer, a financial institution representative, or an administrator) to interact with the electronic display by touching or pointing at display areas to provide information to the user control interface. In additional embodiments, the computing device 204 may include an optical device such as a digital camera, video camera, optical scanner, or the like, such that the computing device can capture, store, and transmit digital images and/or videos.

The computing devices 204 may include a user control interface that enables one or more users to share information and commands with the computing devices or server devices 202. The user interface may comprise one or more functionable inputs such as buttons, keyboard, switches, scrolls wheels, voice recognition elements such as a microphone, and pointing devices such as mice, touchpads, tracking balls, and styluses. The user control interface may also include a speaker for providing audible instructions and feedback. Further, the user control interface may comprise wired or wireless data transfer elements, such as a communication component, removable memory, data transceivers, and/or transmitters, to enable the user and/or other computing devices to remotely interface with the computing device 204.

The communications network 206 may be wired or wireless and may include servers, routers, switches, wireless receivers and transmitters, and the like, as well as electrically conductive cables or optical cables. The communications network 206 may also include local, metro, or wide area networks, as well as the Internet, or other cloud networks. Furthermore, the communications network 206 may include cellular or mobile phone networks, as well as landline phone networks, public switched telephone networks, fiber optic networks, or the like.

Both the server devices 202 and the computing devices 204 may be connected to the communications network 206. Server devices 202 may be able to communicate with other server devices 202 or computing devices 204 through the communications network 206. Likewise, computing devices 204 may be able to communicate with other computing devices 204 or server devices 202 through the communications network 206. The connection to the communications network 206 may be wired or wireless. Thus, the server devices 202 and the computing devices 204 may include the appropriate components to establish a wired or a wireless connection.

The computer program of the present invention may run on computing devices 204 or, alternatively, may run on one or more server devices 202. Thus, a first portion of the program, code, or instructions may execute on a first server device 202 or a first computing device 204, while a second portion of the program, code, or instructions may execute on a second server device 202 or a second computing device 204. In some embodiments, other portions of the program, code, or instructions may execute on other server devices 202 as well. For example, information particular to each consumer may be stored on a memory element associated with the server device 202, such that the information particular to each consumer is remotely accessible to a financial institution representative using the computer program via one or more computing devices 204. Alternatively, the information particular to each consumer may be directly stored on the memory element associated with the one or more computing devices 204 of the financial representative user. In additional embodiments of the present invention, a portion of the information to implement the present invention may be stored on the server device 202, while another portion may be stored on the one or more computing devices 204. The various actions, analyses (including underwriting and credit worthiness analyses), and calculations described herein as being performed by or using the computer program may actually be performed by one or more computers, processors, or other computational devices, such as the computing devices 204 and/or server devices 202, independently or cooperatively executing portions of the computer program.

In certain embodiments of the present invention, the computer program may be embodied in a stand-alone program downloaded on a user's computing device 204 or in a web-accessible program that is accessible by the user's computing device 204 via the network 206. For the stand-alone program, a downloadable version of the computer program may be stored, at least in part, on the server device 202. A user can download at least a portion of the computer program onto the computing device 204 via the network 206. In such embodiments of the present invention, the computer program may be an “application,” such as an “app” for a mobile device. After the computer program has been downloaded, the program can be installed on the computing device 204 in an executable format. The executable form of the program permits the user to access embodiments of the present invention via an electronic resource, such as a mobile “app” or website. For the web-accessible computer program, the user may simply access the computer program via the network 206 (e.g., the Internet) with the computing device 204.

Once the user has access to the electronic resource, via the computer program installed on a user's computing device 204 or the web, certain embodiments may provide for users to create accounts with which to access the electronic resource. The user accounts may be stored within the memory elements of the server 206 or in the respective databases. Certain embodiments of the present invention may provide for at least three types of user accounts, including a consumer account, a financial institution account, and an administrative account. Each user account may provide users with unique roles, capabilities, and permissions with respect to implementing embodiments of the present invention. However, such embodiments are provided for exemplary purposes only, and other embodiments of the present invention may include any number and/or any specific types of account as may be necessary to carry out the functions, features, and/or implementations of the present invention. For instance, certain other embodiments may provide for a role-based security feature, such that administrative users, through their administrative accounts, may establish, maintain, and oversee a plurality of different types account. Thus, the administrative users may establish and manage the roles, capabilities, and permissions of each of the different types of accounts.

Returning to the embodiments detailed above with three types of user accounts, the consumer account is an account created by or for the consumer desiring to obtain the hybridized secured credit financial product of the present invention. The consumer may establish a consumer account, and via such account enter consumer information necessary for the administrator and/or financial institution to evaluate providing the financial product to the consumer. As such, the consumer may enter personal information (name, address, social security number, income, employer, banking information). Additionally, other information may be associated with the consumer account, such as a credit report, impending payments to be received, etc.

The financial institution account is a user account established by or for a representative of a financial institution (“FI”). The FI representative may access the account to review information particular to a consumer. As such, the FI representative may be able to access some or all of the consumer account or, at the least, access data entered or stored on behalf of the consumer. The FI representative may also perform underwriting and credit worthiness analyses via the FI account, review guidelines for providing a consumer the financial product, and perform other necessary actions or functions for implementing the steps of the present invention. In embodiments of the present invention, the FI account may also access a secondary computer program of the present invention that performs the calculations to determine if the consumer is eligible for the financial product.

The administrative account is a user account created by or for an administrator of the present invention. The administrator may be a person or entity that offers the hybridized secured credit financial product to the consumer. In exemplary cases, the administrator may be a tax preparer that prepares the consumer's tax return. As part of preparation of the tax return, the administrator will know if the consumer is receiving a tax refund and the amount of the refund. The administrator can then offer the consumer the financial product so that the consumer may obtain at least a portion of their tax return immediately, as opposed to having to wait for receipt from the Internal Revenue Service or other government taxing authority. The above example of the administrator as a tax preparer is intended only to illustrate the present invention and should not be considered limiting. As such, in alternative embodiments, the administrator may be a financial institution offering various financial products, including the financial product described herein, a social media site, such as Facebook™, an e-commerce site, such as Amazon™, or an online payments network, such as PayPal™.

The administrative user may make use of various embodiments of the present invention to manage the financial product offerings, store, download, enter, or otherwise access consumer information, and review eligible financial product offerings. In additional embodiments of the present invention, the administrative user may establish and manage the consumer account and/or the FI account.

In embodiments of the present invention, the administrator forms a business relationship with the financial institution. Because the administrator is the entity with a relationship with the consumer, the administrator is in the best position to determine if the consumer is a likely candidate for the financial product described herein and offer such product to the consumer. However, it is contemplated that in most circumstances, the administrator is not going to be a financial institution that can actually establish the described first and second financial accounts. As such, the administrator may work with the financial institution to offer the consumer the financial product. In alternative embodiments of the present invention, the administrator may control the financial institution, the financial institution may control the administrator, or the administrator and the financial institution may be controlled by the same entity.

Although certain details and descriptions provided below discuss certain functions, features, and/or implementations of the present invention being carried out by a particular type of user or user account, it is hereby understood that such descriptions are simply provided for illustrative purposes. Thus, for example, certain functions described below as being performed by a consumer user may likewise be performed by an administrative user, and such is similarly applicable to other types of users and user accounts as may be required.

Regardless of the type of user account created, each user with an account may be required to enter, or have entered, various pieces of identification information, such as email address and name. In addition, the user may be required to enter or will otherwise be provided with a username and password, which may be required for the user to login to the user's account and access the electronic resource. All information entered by the user is received, via the network 206, and may be stored on the server device 202 or respective database.

Although certain embodiments of the present invention may require a user to establish an account, certain other embodiments may provide for certain features of the present invention to be utilized, such as browsing financial product offerings, without requiring the establishment of a user account. For instance, a potential consumer may access an online resource that hosts the present invention, such as an online website, and browse the financial products and criteria for same without needing to register or create an account.

### Method and Computer Program Description

The method and computer program of the present invention provide for an initial step of a consumer applying for a first financial account that is a secured credit account having a secured line of credit. The first financial account is established by (i.e., held at) a financial institution. As set forth in Step 100, the computer program and method of the present invention receive the request, from the consumer, to open the secured credit account. Generally commensurate with the consumer's request, the consumer may complete an application (or a representative of the consumer may complete the application) for opening the secured credit account. The application may include the consumer's personal information, such as a name, address, social security number, etc., as well as income and/or salary information and other information used to determine the credit worthiness of the consumer.

In embodiments of the present invention, initial underwriting of the consumer is performed to even determine whether the consumer's request for the secured credit account should be approved. This is to be differentiated from the step of determining a collateral funding amount required for securing the secured credit account. In certain embodiments, initial underwriting (i.e., credit approval) decisions may be made based solely on the consumer's credit, income information, and/or other information obtained from the consumer in the secured credit account application. Alternatively, information to assist in performing underwriting risk analysis may be provided by the consumer directly (such as the consumer's tax information) or may be provided by third-party sources, such as a payroll provider.

After or generally commensurate with the initial underwriting and assuming the consumer has been approved for the secured credit account, embodiments of the present invention next determine, at Step 102, a collateral funding amount available from a source of collateral funds associated with the consumer, wherein the collateral funding amount is used as collateral for the secured credit account. The consumer allocates or otherwise designates at least a portion of the consumer's source of collateral funds that the consumer desires to fund into a second financial account. The consumer may be guided by the financial institution and/or an administrator of the secured credit financial product in designating the collateral funding amount used as collateral for the secured credit account. For example, if the consumer desires to have a relatively lower credit limit as compared to the available collateral, the consumer may allocate or designate only a portion of the funds at the source of collateral funds to be used as collateral for the secured credit account. Alternatively, the consumer may desire that only a portion of an impending payment be designated as collateral for the secured credit account, such that the consumer may access the remaining portion of the impending payment without restriction.

Embodiments of the present invention contemplate that the source of collateral funds may be previously existing monetary funds (e.g., a savings account, a retirement/investment account, a tax refund transfer account), a home or vehicle title, stocks, bonds, or other assets of the consumer. In even further embodiments, the source of collateral funds may be an impending payment that the consumer expects to receive, such as a tax refund or other onetime or periodic payment. Exemplary onetime or period payments, in addition to a tax refund, include, without limitation, social security payments or other government payments, distributions from investments, insurance payouts, lottery winning proceeds, and other impending payments.

Upon or generally commensurate with the source of collateral funds and collateral funding amount being designated by the consumer, embodiments of the present invention establish, at Step 104, a second financial account having the consumer as an accountholder and for depositing of the collateral funding amount in the second financial account. The collateral funding amount represents the collateral dollar amount used to secure the secured credit account (i.e., the first financial account). Establishment of the second financial account comprises either opening a new financial account that is then identified as the second financial account or identifying an already-opened and held financial account of the consumer as the second financial account. The second financial account may be a savings account or a demand deposit account held at a financial institution. The second financial account may be held at the same, or at a different, financial institution than the financial institution that holds the first financial account. It is to be understood that the collateral funds will be deposited in or otherwise associated with the second financial account, and as such, the consumer's access to the collateral funds may be restricted.

Upon or generally commensurate with the source of collateral funds being identified and the second financial account being established, embodiments of the present invention determine an initial credit limit and a regular credit limit for the secured credit account (Steps 106 and 108). The initial credit limit represents an initial monetary amount available to the consumer for a period of time prior to all of the collateral funding amount being deposited in or otherwise associated with the second financial account, i.e., before the collateral is secured. In contrast, the regular credit limit for the secured credit account represents a regular monetary amount available to the consumer after all of the collateral funding amount has been deposited in or otherwise associated with the second financial account, i.e., after the collateral is secured. In determining the collateral funding amount, embodiments of the present invention may also verify that the source of collateral funds has the funding amount available for serving as collateral for the secured credit account.

The regular and initial credit limit amounts may be determined based on a variety of factors, including the credit worthiness of the consumer, a type of the source of collateral funds, an expected date of depositing in or otherwise associating the collateral funding amount with the second financial account, a probability that the source of collateral funds will be realized, and a frequency of payments via the source of collateral funds. The financial institution or the administrator of the hybridized secured credit financial product may perform a risk analysis to consider the type and amount of the source of collateral funds. For example, if the source is an impending payment that is to be received by the consumer and to be deposited into the second financial account, certain types of payments, such as tax refunds or regular government payments (e.g., social security payments), may have a higher likelihood of being successfully deposited, while other types of payments, such as external bank account transfers, may have a lower likelihood of being deposited. Thus, the source of collateral funds may be assigned a credibility rating depending on a probability that the source of collateral funds will eventually be realized. Embodiments of the present invention may implement various underwriting algorithms and risk analyses to determine an appropriate initial credit limit.

In embodiments and depending on application of the factors identified immediately above, the regular credit limit for the secured credit account may be less than, equal to, or greater than the collateral funding amount the consumer has designated for depositing into the second financial account. In other embodiments, the initial credit limit may be the same as or equal to the collateral funding amount (such that the regular credit limit would be greater than the collateral funding amount). In even further embodiments, the initial credit limit may be equal to or less than the regular credit limit. As should be appreciated, the financial institution or the administrator may establish the initial and regular credit limits depending on the variety of factors identified above, and the initial and regular credit limits need not necessarily be generally the same as the collateral funding amount or proportional to the collateral funding amount.

In yet further embodiments, the consumer may be offered more than one initial credit limit. For example, a first initial credit limit may be established for a preset period of time or for a period of time prior to a portion of the collateral funding amount being secured. Upon the portion of the collateral funding amount being secured, the consumer may be offered a second initial credit limit, which may be implemented for another preset period of time or for a period of time prior to a second portion of the collateral funding amount being secured. If the second portion of the collateral funding amount is the entire expected collateral funding amount, then the second initial credit limit may be offered until the collateral funding amount is completely secured. Thus, embodiments of the present invention contemplate a tiered secured credit line process that may fluctuate depending on the amount of collateral secured at any given time. This allows for providing different credit limits based on the expected collateral funding, such as may occur if the consumer is to receive more than one tax refund (e.g., federal and state tax refunds). For example, the consumer may initially be given the first initial credit limit, but upon the federal tax refund being deposited into the second financial account, and thus, at least a portion of the collateral funding amount being secured, the consumer's credit limit may be raised to a second initial credit limit that is less than the regular credit limit. The second initial credit limit is available until the consumer's state tax refund is deposited into the second financial account, and thus, until the entire collateral funding amount is secured. At this point, the consumer's credit limit is raised to the regular credit limit.

Embodiments of the present invention next provide access to the consumer, via the secured credit account and prior to all of the collateral funding amount being deposited in said second financial account, of the initial monetary amount (which represents the initial credit limit), such that the consumer may access the initial monetary amount using the consumer's secured credit account and prior to the second financial account being fully funded with the collateral funding amount (Step 110). In embodiments of the present invention, the consumer may access the initial monetary amount held at the secured credit account via a spending vehicle. In embodiments of the present invention, the consumer is immediately provided with a general purpose prepaid card issued to the consumer and loaded with the initial monetary amount. The general purpose prepaid card may be either reloadable (as may exist within an open loop payments system) or not reloadable (as may exist within a closed loop payments system). The prepaid card may also be a traditional gift card branded for use at one or more particular merchants or at a particular e-commerce site. With the prepaid card, the consumer may access the initial monetary amount via standard debit and/or prepaid card transactions, such as automated teller machine transactions or point of sale purchases. Alternatively, the consumer may be immediately provided with a traditional credit card having a credit limit equal to the initial credit limit. The consumer may then obtain a cash advance or use the credit card for purchases up to and equaling the initial credit limit. In yet further embodiments, the spending vehicle may comprise a credit to the consumer's PayPal™ or Google Wallet™ account or electronic transfer of a credit card number that can be used by the consumer for e-commerce purchases or associated with a payments product of the consumer (e.g., if the consumer associates credit card numbers to be accessed via the consumer's mobile communications device). The spending vehicle may also comprise a bank transfer (i.e., ACH or wire transfer) to a financial account held by the consumer. Such a bank transfer may be made from the financial institution maintaining the secured credit account and to the consumer's own bank or to another financial institution. In even additional embodiments, the initial monetary amount may be provided to the consumer by way of a physical check. As directed by the consumer, such a check may be delivered to a mailing address of the consumer, or the check may be printed on demand and picked up by the consumer. Thereafter, the consumer can deposit or cash the check to gain access to the initial monetary amount. Therefore, any mechanism for providing the consumer with immediate access to the initial monetary amount is contemplated by embodiments of the present invention.

It is to be understood that the consumer would either in person or electronically apply for the hybridized secured credit financial product, undergo the underwriting process, be approved for an initial and a regular credit limit, and thereafter immediately receive the general purpose prepaid card or other spending vehicle. Embodiments of the present invention thus provide a spending vehicle to the consumer that may be immediately used by the consumer to access funds equaling the initial credit limit.

To complete the consumer's access to the regular monetary amount corresponding to the regular credit limit of the financial product of embodiments of the present invention, the first financial institution and/or the administrator of the financial product receives a notice that all of the collateral funding amount is deposited into the second financial account (Step 112). As can be appreciated, it should be rare that the entire collateral funding amount is not deposited into the second financial account, as such would only happen if the source of the collateral funds failed and thus, the collateral was not realized or secured. It is expected that in most instances of a consumer obtaining the secured credit account, the source of collateral funds will eventually deposit in or otherwise associate the collateral funding amount with the second financial account. In embodiments, the collateral funding amount is the same as, is less than or equal to, or is greater than or equal to the regular credit limit.

Upon receiving notice that that all of the collateral funding amount is deposited into the second financial account, the consumer's secured credit account is authorized for the regular credit limit. As such, embodiments of the present invention then provide access to the consumer, via the secured credit account and only after all of the collateral funding amount is deposited in said second financial account, of the regular monetary amount, such that the consumer may access the regular monetary amount using the consumer's secured credit account and only after the second financial account is fully funded with the collateral amount (Step 114). It should be appreciated that if the consumer has already accessed some or all of the initial credit limit, the available monetary amount once the regular credit limit is authorized may be less than the regular monetary amount, i.e., the available monetary amount may be the difference in the regular credit limit and the initial credit limit already accessed by the consumer.

In embodiments of the present invention, because the initial monetary amount is an extension of credit from the secured line of credit, the consumer is required to repay the initial monetary amount (or accessed/used portion thereof) irrespective of whether the collateral funding amount was eventually received and deposited in the consumer's second financial account. For instance, if the source of collateral funds was a tax refund, and for some reason the tax refund was not paid by the taxing authority, the consumer would still be responsible for repaying the initial monetary amount that was initially extended from the secured line of credit to the consumer. The consumer may repay the initial monetary amount through standard repayment channels, such as through checks, Automated Clearing House (“ACH”) transactions, bank transfers, account transfers, or the like. Once the collateral funding amount has been received and deposited into the second financial account, the consumer may repay the initial monetary amount by implementing a funds transfer from the second financial account and to the secured credit account. To maintain the ability to access the secured credit account, the consumer must make any required minimum monthly payments associated with the secured line of credit.

As an example of the methods and functions described herein, consider a consumer that files her taxes and is notified that she is entitled to receive a $3,000 tax refund. Generally, the consumer would be required to wait approximately four to six weeks before a taxing authority would remit the tax refund to the consumer. However, according to embodiments of the present invention, the consumer may apply for a secured line of credit from which the consumer may gain access to an instant cash advance. For instance, upon being approved for the secured credit account, the consumer may indicate that she wishes for the entire $3,000 tax refund amount to be deposited into the second financial account for use as the collateral funding amount for the secured line of credit associated with the secured credit account. After the first financial institution and/or an administrator verifies that the tax refund is expected to be received by the consumer (e.g., by reviewing/confirming the consumer's tax return), the financial institution establishes a $3,000 secured line of credit for the consumer accessible at the secured credit account. Because the line of credit is a secured line of credit, the line of credit cannot be fully accessed by the consumer until the tax refund is received and deposited into the second financial account. However, the financial institution may perform an underwriting analysis to determine if the consumer is entitled to instant and immediate funds prior to the collateral being secured. In the present example, the consumer may be entitled to receive $500 of the $3,000 line of credit as a cash advance. The $500 cash advance (which represents the initial monetary amount corresponding to the initial credit limit) may be provided instantly to the consumer via a general purpose prepaid card. The consumer can then immediately use the prepaid card to make purchases and/or withdrawals up to $500. The consumer would have access to the remaining $2,500 from the secured line of credit once the tax refund was received and deposited into the second financial account (i.e., one the collateral is secured). As described above, regardless of whether the tax refund was eventually received, the consumer is responsible for repaying the $500 that was an advance from the secured line of credit. However, once the tax refund is received and deposited into the second financial account, the consumer may repay the secured line of credit by initiating a funds transfer from the second financial account and to the secured credit account. In certain embodiments, the amount of the line of credit may be tied to the balance of the second financial account. Thus, for instance, if after the tax return was deposited into the second financial account and after the consumer repaid the $500 initial monetary amount from the second financial account, then the second financial account would have a balance of $2,500 and the consumer's secured line of credit associated with the secured credit account would be correspondingly reduced to $2,500.

Although the invention has been described with reference to the preferred embodiment(s), it is noted that equivalents may be employed and substitutions made herein without departing from the scope of the invention. Thus, the invention described herein is entitled to those equivalents and substitutions that perform substantially the same function in substantially the same way.

1. A non-transitory computer-readable medium having a computer program stored thereon for execution by a processor, the computer program operable to provide a consumer immediate access to funds via a hybridized secured credit financial product, wherein execution of the computer program by the processor performs the steps of:
receive a request, from the consumer, to open a first financial account that is a secured credit account;
determine a collateral funding amount available from a source of collateral funds associated with the consumer, wherein the collateral funding amount is used as collateral for the secured credit account;
establish a second financial account for depositing of the collateral funding amount in said second financial account;
determine an initial credit limit for the secured credit account, wherein the initial credit limit represents an initial monetary amount available to the consumer for a period of time prior to all of the collateral funding amount being deposited in said second financial account;
determine a regular credit limit for the secured credit account, wherein the regular credit limit represents a regular monetary amount available to the consumer after all of the collateral funding amount has been deposited in said second financial account;
provide access to the consumer, via the secured credit account and prior to all of the collateral funding amount being deposited in said second financial account, of the initial monetary amount, such that the consumer may access the initial monetary amount using the consumer's secured credit account and prior to the second financial account being fully funded with the collateral amount;
receive notice that all of the collateral funding amount is deposited into the second financial account; and
provide access to the consumer, via the secured credit account and only after all of the collateral funding amount is deposited in said second financial account, of the regular monetary amount, such that the consumer may access the regular monetary amount using the consumer's secured credit account and only after the second financial account is fully funded with the collateral amount.

2. The computer program of claim 1, wherein the step of providing access to the consumer of the initial monetary amount is performed on the same day as or within twenty-four hours of receiving the consumer's request to open the first financial account.

3. The computer program of claim 2, wherein the step of providing access to the consumer of the initial monetary amount corresponding to the initial credit limit further includes the step of loading a prepaid card with the initial monetary amount and providing the prepaid card to the consumer.

4. The computer program of claim 1, wherein the collateral funding amount is equal to or greater than the regular credit limit, and the initial credit limit is less than or equal to the regular credit limit.

5. The computer program of claim 1, wherein the step of determining a collateral funding amount further includes the step of verifying that the source of collateral funds has the funding amount available for serving as collateral for the first financial account.

6. The computer program of claim 2, wherein the source of collateral funds is selected from the group consisting of a tax refund from a government entity, a one-time or periodic payment from a government entity or financial institution, and a third financial account associated with the consumer.

7. The computer program of claim 6, wherein the initial and regular credit limits are determined based on the collateral funding amount and a type of the source of collateral funds.

8. The computer program of claim 7, wherein execution of the computer program by the processor assigns a credibility rating to the source of collateral funds, and said credibility rating is dependent on a probability that the source of collateral funds will eventually be realized.

9. The computer program of claim 8, wherein the credibility rating is higher for tax refunds and one-time or periodic payments from government entities than the third financial account associated with the consumer.

10. A method of providing a consumer immediate access to funds via a hybridized secured credit financial product, the method comprising the steps of:
receiving a request, from the consumer, to open a first financial account that is a secured credit account;
determining, via a processor, a collateral funding amount available from a source of collateral funds associated with the consumer, wherein the collateral funding amount is used as collateral for the secured credit account;
establishing a second financial account for depositing of the collateral funding amount in said second financial account;
determining, via a processor, an initial credit limit for the secured credit account, wherein the initial credit limit represents an initial monetary amount available to the consumer for a period of time prior to all of the collateral funding amount being deposited in said second financial account;
determining, via a processor, a regular credit limit for the secured credit account, wherein the regular credit limit represents a regular monetary amount available to the consumer after all of the collateral funding amount has been deposited in said second financial account;
providing access to the consumer, via the secured credit account and prior to all of the collateral funding amount being deposited in said second financial account, of the initial monetary amount, such that the consumer may access the initial monetary amount using the consumer's secured credit account and prior to the second financial account being fully funded with the collateral amount;
receiving, via a processor, notice that all of the collateral funding amount is deposited into the second financial account; and
providing access to the consumer, via the secured credit account and only after all of the collateral funding amount is deposited in said second financial account, of the regular monetary amount, such that the consumer may access the regular monetary amount using the consumer's secured credit account and only after the second financial account is fully funded with the collateral amount.

11. The method of claim 10, wherein the step of providing access to the consumer of the initial monetary amount is performed on the same day as or within twenty-four hours of receiving the consumer's request to open the first financial account.

12. The method of claim 11, wherein the step of providing access to the consumer of the initial monetary amount corresponding to the initial credit limit further includes the step of loading a prepaid card with the initial monetary amount and providing the prepaid card to the consumer.

13. The method of claim 10, wherein the collateral funding amount is equal to or greater than the regular credit limit, and the initial credit limit is less than or equal to the regular credit limit.

14. The method of claim 10, wherein the step of determining a collateral funding amount further includes the step of verifying that the source of collateral funds has the funding amount available for serving as collateral for the first financial account.

15. The method of claim 11, wherein the source of collateral funds is selected from the group consisting of a tax refund from a government entity, a one-time or periodic payment from a government entity or financial institution, and a third financial account associated with the consumer.

16. The method of claim 15, wherein the initial and regular credit limits are determined based on the collateral funding amount and a type of the source of collateral funds.

17. The method of claim 16, further including the step of assigning a credibility rating to the source of collateral funds, wherein said credibility rating is dependent on a probability that the source of collateral funds will eventually be realized.

18. The method of claim 17, wherein the credibility rating is higher for tax refunds and one-time or periodic payments from government entities than the third financial account associated with the consumer.

19. A system for providing a consumer immediate access to funds via a hybridized secured credit financial product, the system comprising:
a processor; and
a non-transitory computer-readable medium having a computer program stored thereon for execution by the processor, wherein execution of the computer program by the processor performs the steps of:
receive a request, from the consumer, to open a first financial account that is a secured credit account;
determine a collateral funding amount available from a source of collateral funds associated with the consumer, wherein the collateral funding amount is used as collateral for the secured credit account;
establish a second financial account for depositing of the collateral funding amount in said second financial account;
determine an initial credit limit for the secured credit account, wherein the initial credit limit represents an initial monetary amount available to the consumer for a period of time prior to all of the collateral funding amount being deposited in said second financial account;
determine a regular credit limit for the secured credit account, wherein the regular credit limit represents a regular monetary amount available to the consumer after all of the collateral funding amount has been deposited in said second financial account;
provide access to the consumer, via the secured credit account and prior to all of the collateral funding amount being deposited in said second financial account, of the initial monetary amount, such that the consumer may access the initial monetary amount using the consumer's secured credit account and prior to the second financial account being fully funded with the collateral amount;
receive notice that all of the collateral funding amount is deposited into the second financial account; and
provide access to the consumer, via the secured credit account and only after all of the collateral funding amount is deposited in said second financial account, of the regular monetary amount, such that the consumer may access the regular monetary amount using the consumer's secured credit account and only after the second financial account is fully funded with the collateral amount.

20. The system of claim 19,
wherein said step of providing access to the consumer of the initial monetary amount is performed on the same day as or within twenty-four hours of receiving the consumer's request to open the first financial account,
wherein the source of collateral funds is selected from the group consisting of a tax refund from a government entity, a one-time or periodic payment from a government entity or financial institution, and a third financial account associated with the consumer,
wherein the initial and regular credit limits are determined based on the collateral funding amount and a type of the source of collateral funds,
wherein execution of the computer program by the processor assigns a credibility rating to the source of collateral funds, and said credibility rating is dependent on a probability that the source of collateral funds will eventually be realized, and
wherein the credibility rating is higher for tax refunds and one-time or periodic payments from government entities than the third financial account associated with the consumer.
